(19) United States
(12) Patent Application Publication
(10) Pub. No.: US 2008/0178050 A1
(43) Pub. Date: Jul. 24, 2008

(54) DATA BACKUP SYSTEM AND METHOD FOR SYNCHRONIZING A REPLICATION OF PERMANENT DATA AND TEMPORARY DATA IN THE EVENT OF AN OPERATIONAL ERROR

(75) Inventors: Robert F. Kern, Otter Rock, OR (US); David B. Petersen, Great Falls, VA (US); David H. Surman, Marlboro, NY (US); Peter G. Sutton, LaGrangeville, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/626,204

(22) Filed: Jan. 23, 2007

(51) Int. Cl. G06F 11/07

(52) U.S. Cl. 714/54; 714/E11.02

(57) ABSTRACT

A data backup system and a method for sychronizing a replication of permanent data between primary and secondary disk subsystems and a replication of temporary data between primary and secondary computer servers in the event of an operational error are provided. The method includes detecting an operational error. The method further includes stopping replication of permanent data from the primary disk subsystem to the secondary disk subsystem at a first predetermined time, in response to the detection of the operational error. The method further includes stopping any further replication of temporary data from the primary computer server to the secondary computer server at the first predetermined time, in response to the detection of the operational error.

### FIELD OF INVENTION

The present application relates to a data backup system and a method for synchronizing a replication of permanent data between primary and secondary disk subsystems and a replication of temporary data between primary and secondary computer servers in the event of an operational error.

### BACKGROUND OF INVENTION

A computer system has been developed that replicates data from a disk storage device to another disk storage device. In particular, the computer system has a primary computer, a secondary computer, a primary disk storage device, and a secondary disk storage device. The primary computer communicates with the primary disk storage device and both are located at a primary site. The secondary computer communicates with the secondary disk storage device and both are located at a remote site. During operation, temporary data from the primary computer is replicated to the secondary computer. Further, hardened data from the primary disk storage device is replicated to the secondary disk storage device.

A problem associated with this computer system is that when an operational error occurs, the replication of the temporary data from the primary computer to the secondary computer may not stop at the same time as the replication of the hardened data from the primary computer to the secondary disk subsystem. Further, the temporary data on the secondary computer is deleted since is it not synchronized with the hardened data on the secondary disk storage device. Accordingly, when the secondary computer has to take over tasks normally performed by the primary computer, a relatively long process of reconstructing the correct temporary data on the secondary computer is utilized.

Accordingly, the inventors herein have recognized a need for an improved system and method for synchronizing the replication of permanent data between primary and secondary disk subsystems and the replication of temporary data between primary and secondary computer servers.

### SUMMARY OF INVENTION

A method for synchronizing a replication of permanent data between primary and secondary disk subsystems and a replication of temporary data between primary and secondary computer servers, in the event of an operational error, in accordance with an exemplary embodiment is provided. The method includes writing permanent data from the primary computer server to the primary disk subsystem. The method further includes replicating the permanent data from the primary disk subsystem to the secondary disk subsystem. The method further includes generating temporary data in the primary computer server. The method further includes replicating the temporary data from the primary computer server to the secondary computer server. The method further includes detecting the operational error. The method further includes stopping any further replication of permanent data from the primary disk subsystem to the secondary disk subsystem at a first predetermined time, in response to detecting the operational error. The method further includes stopping any further replication of temporary data from the primary computer server to the secondary computer server at the first predetermined time, in response to detecting the operational error.

A data backup system in accordance with another exemplary embodiment is provided. The data backups system includes a primary computer server. The data backup system further includes a secondary computer server operably communicating with the primary computer server. The data backup system further includes a primary disk subsystem operably communicating with the primary computer server. The data backup system further includes a secondary disk subsystem operably communicating with the primary disk subsystem. The primary computer server is configured to write permanent data to the primary disk subsystem. The primary disk subsystem is configured to replicate the permanent data to the secondary disk subsystem. The primary computer server is configured to generate temporary data. The primary computer server is further configured to replicate the temporary data from the primary computer server to the secondary computer server. The secondary computer server is configured to detect an operational error and to send a message to the primary disk subsystem in response to detecting the operational error. The primary disk subsystem is further configured to stop any further replication of permanent data from the primary disk subsystem to the secondary disk subsystem at a first predetermined time, in response to the message. The primary computer server is further configured to stop any further replication of temporary data from the primary computer server to the secondary computer server at the first predetermined time, in response to detection of the operational error.

One or more computer readable media having computer-executable instructions implementing a method for synchronizing a replication of permanent data between primary and secondary disk subsystems and a replication of temporary data between primary and secondary computer servers in the event of an operational error, in accordance with another exemplary embodiment is provided. The method includes writing permanent data from the primary computer server to the primary disk subsystem. The method further includes replicating the permanent data from the primary disk subsystem to the secondary disk subsystem. The method further includes generating temporary data in the primary computer server. The method further includes replicating the temporary data from the primary computer server to the secondary computer server. The method further includes detecting the operational error. The method further includes stopping any further replication of permanent data from the primary disk subsystem to the secondary disk subsystem at a first predetermined time, in response to detecting the operational error. The method further includes stopping any further replication of temporary data from the primary computer server to the secondary computer server at the first predetermined time, in response to detecting the operational error.

A method for synchronizing a replication of permanent data between primary and secondary disk subsystems and a replication of temporary data between primary and secondary computer servers in an event of an operational error, in accordance with another exemplary embodiment. The method includes replicating permanent data written from the primary computer server to the primary disk subsystem from the primary disk subsystem to the secondary disk subsystem. The method further includes replicating temporary data generated in the primary computer server from the primary computer server to the secondary computer server. The method further includes in response to detection of the operational error, stopping any further replication of permanent data from the primary disk subsystem to the secondary disk subsystem and simultaneously stopping any further replication of temporary data from the primary computer server to the secondary computer server.

An apparatus for synchronizing a replication of permanent data between primary and secondary disk subsystems and a replication of temporary data between primary and secondary computer servers in an event of an operational error, in accordance with another exemplary embodiment is provided. The apparatus includes means for replicating permanent data written from the primary computer server to the primary disk subsystem from the primary disk subsystem to the secondary disk subsystem. The apparatus further includes means for replicating temporary data generated in the primary computer server from the primary computer server to the secondary computer server. The method further includes means responsive to detection of the operational error, stopping any further replication of permanent data from the primary disk subsystem to the secondary disk subsystem and simultaneously stopping any further replication of temporary data from the primary computer server to the secondary computer server.

### BRIEF DESCRIPTION OF DRAWINGS

FIG. 1 is a block diagram of a data backup system in accordance with an exemplary embodiment;

FIG. 2 is a block diagram of a coupling facility utilized by the data backup system of FIG. 1; and

FIGS. 3-6 are flowcharts of a method for synchronizing a replication of permanent data between primary and secondary disk subsystems and a replication of temporary data between primary and secondary computer servers in an event of an operational error.

### DESCRIPTION OF EMBODIMENTS

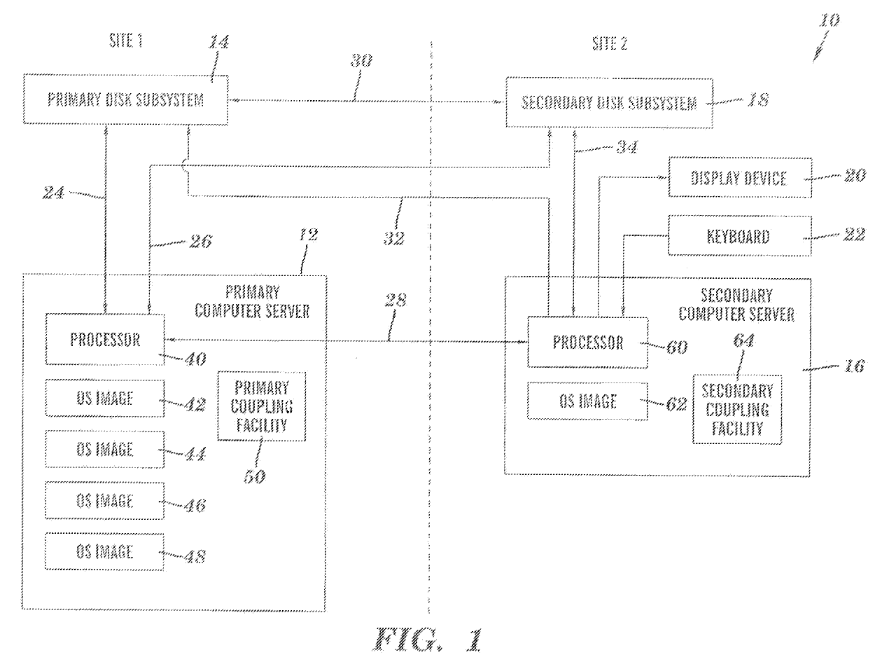

Referring to FIG. 1, a block diagram of a data backup system 10 in accordance with an exemplary embodiment is illustrated. The data backup system 10 synchronizes a replication of permanent data and temporary data, in the event of an operational error, as will be described below. For purposes of understanding, permanent data is defined as data that is written and stored in a disk subsystem. Further, temporary data is defined as cached data. For purposes of understanding, a primary computer server is a computer server located at a primary site or facility. A primary disk subsystem is a disk subsystem located at a primary site or facility. A secondary computer server is a computer server located at a secondary site or facility. A secondary disk subsystem is a disk subsystem located at a secondary site or facility. The data backup system 10 includes a primary computer server 12, a primary disk subsystem 14, a secondary computer server 16, a secondary disk subsystem 18, a display device 20, a keyboard 22, and communication buses 24, 26, 28, 30, 32 and 34.

The primary computer server 12 is a computer server located at a first physical site or facility, referred to as a primary physical site or facility herein, which is provided to execute operating system (OS) images that generate permanent data and temporary data. In particular, the primary computer server 12 includes a processor 40 that executes OS images 42, 44, 46, 48 that generate permanent data and temporary data. The processor 40 writes the permanent data to the primary disk subsystem 14 which stores the permanent data therein. Further, the primary disk subsystem 14 replicates the permanent data to the secondary disk subsystem 18. The processor 40 executes a primary coupling facility 50 to replicate temporary or cached data from the OS images 42, 44, 46, 48 to the secondary coupling facility 64 in the secondary computer server 16. The primary coupling facility 50 utilizes the bus 28 to communicate with the secondary coupling facility 64. The processor 40 operably communicates with the primary disk subsystem 14, the secondary disk subsystem 18, and the processor 60 in the secondary computer server 16, via communication buses 24, 26, 28, respectively.

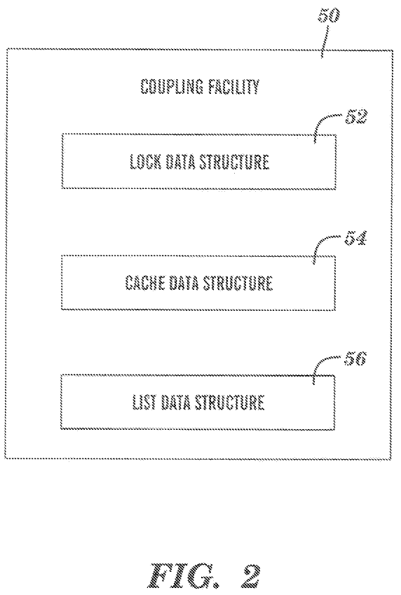

Referring to FIG. 2, the coupling facility 40 utilizes a lock data structure 52, a cache data structure 54, and a list data structure 56. The lock data structure is provided to serialize processes within the OS images on the primary computer server 12 and the secondary computer server 16. The cache data structure 54 is provided for a multi-system shared-data cache coherency management. The purpose of the cache data structure 54 is to enable an existing buffer manager (e.g., a database manager) to be extended in a clustered environment. In particular, it permits each system node to locally cache shared data in processor memory with full data integrity and optimal performance. Further, data can be optionally cached globally in the cache data structure 54 of high speed local buffer refresh. The list data structure 56 is provided to support multi-system queuing constructs that are applicable for a wide range of uses including workload distribution, intersystem message passing, and maintaining shared control block state information. The list data structure 56 can include program specified number of list headers. The list data structure 56 can support queuing of entries in last in, first out/first in, first out (LIFO/FIFO) order or in collating sequence by key under program control. Individual list entries are dynamically generated when first written and queued to a designated list header. List entries can optionally have a corresponding data block attached at the time of generation or subsequent list entry update. Existing entries can be read, updated, deleted, or moved between list hearers, without the need for explicit software multi-system serialization in order to insert or remove entries from a list.

Referring to FIG. 1, the primary disk subsystem 14 is a disk subsystem located at the primary site or facility provided to store permanent data from the primary computer server 12 and to replicate the permanent data to the secondary disk subsystem 18. The primary disk subsystem 14 operably communicates with the processor 40, the secondary disk subsystem 18, and the processor 60 via the communication buses 24, 30, 32. respectively.

The secondary computer server 16 is a computer server located at a second physical site or facility, referred to as a secondary physical site or facility herein, that is provided to execute one or more operating system (OS) images that generate permanent data and temporary data. In particular, the secondary computer server 16 includes a processor 60 that executes at least one OS image 62 that generates permanent data and temporary data. Further, the processor 60 executes a secondary coupling facility 64 to receive replicated temporary or cached data from the OS images 42, 44, 46, 48 via the primary coupling facility 50 in the primary computer server 12. In the event of a detected operational error, the secondary computer server 16 is further configured to execute the OS images 42, 44, 46, 48 therein as will be described further detail below. The processor 60 operably communicates with the primary disk subsystem 14, the secondary disk subsystem 18, and the processor 40 in the primary computer server 12, via communication buses 32, 34, 28, respectively.

The secondary disk subsystem 18 is a disk subsystem located at the secondary physical site or facility provided to store permanent data from the primary disk subsystem 14, and the secondary computer server 16. The secondary disk subsystem 18 operably communicates with the processor 60, the primary disk subsystem 14, and the processor 40 via the communication buses 34, 30, 26, respectively.

The display device 20 is provided to display data from the processor 60. Further, the keyboard 22 is provided to allow a user to input data into the processor 60.

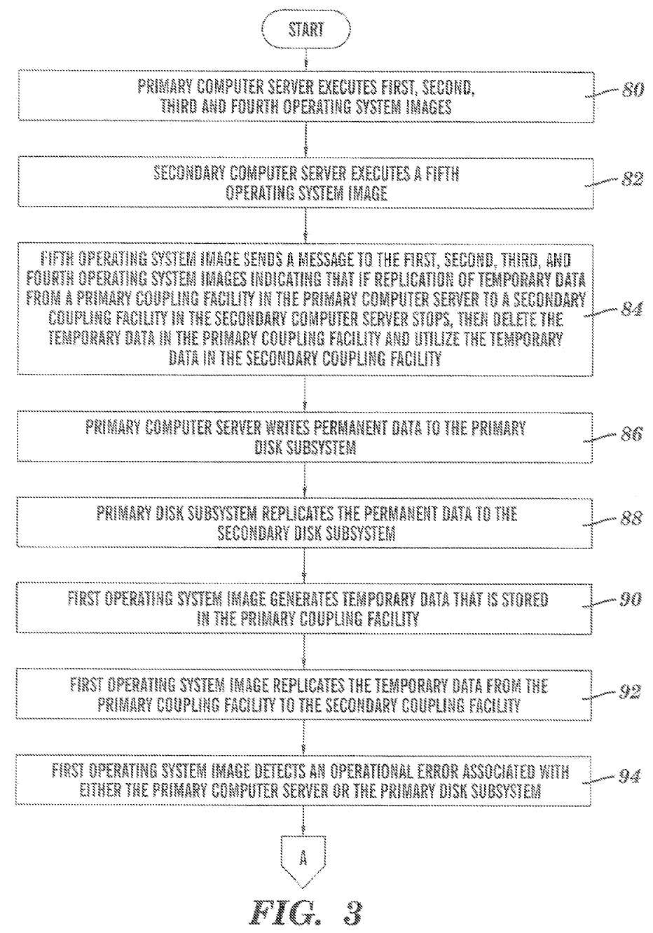

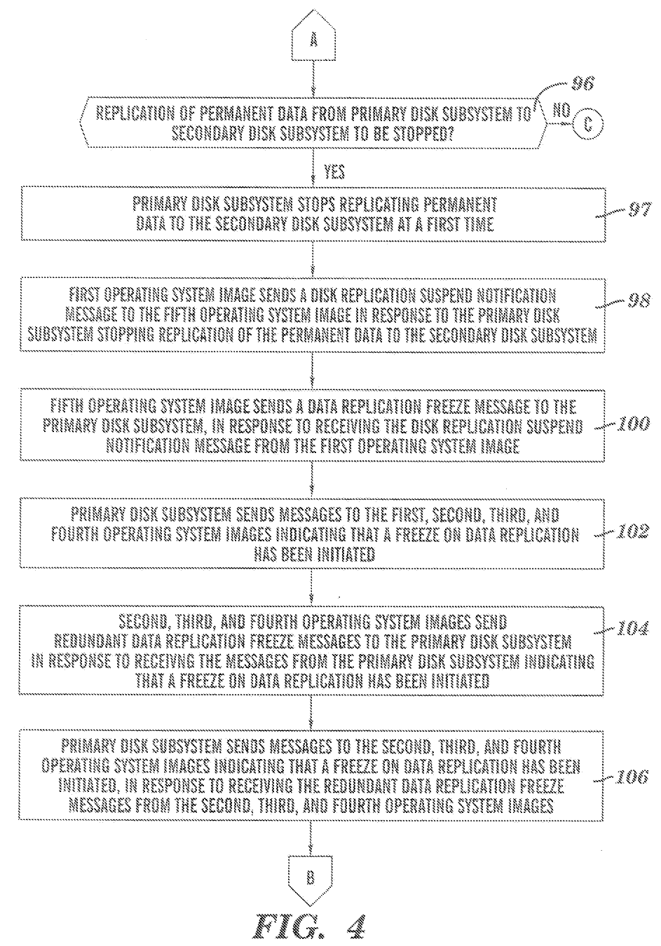

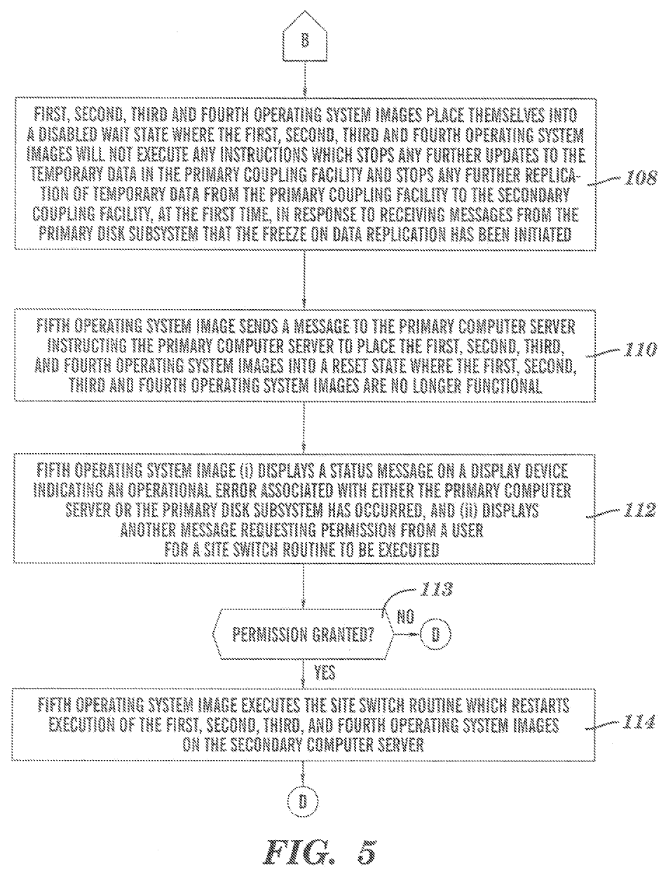

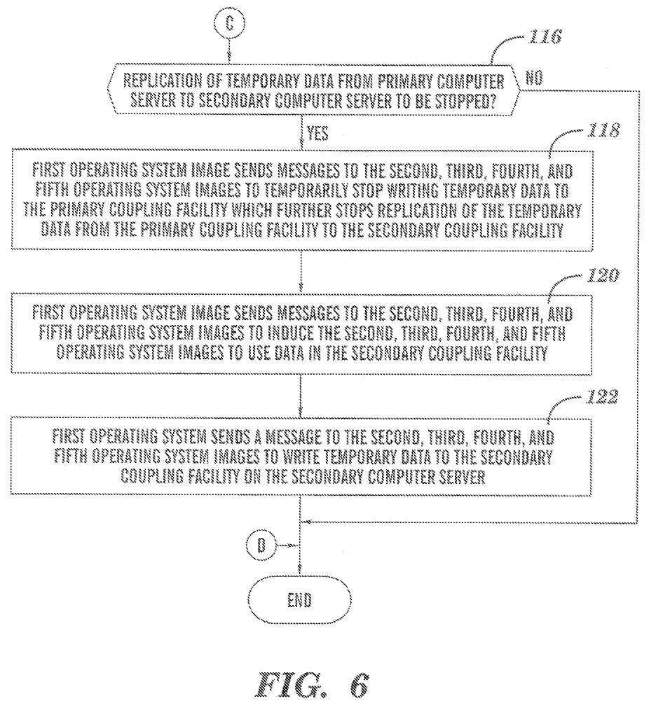

Referring to FIGS. 3-6, a flowchart of a method for synchronizing a replication of permanent data between the disk subsystems 14, 18 and a replication of temporary data between computer servers 12, 16 in the event of an operational error will now be explained.

At step 80, the primary computer server 12 executes OS images 42, 44, 46, 48.

At step 82, the secondary computer server 16 executes the OS image 62.

At step 86, the OS image 62 sends a message to the OS images 42, 44, 46, 48, via the communication bus 28, indicating that if replication of temporary data from the primary coupling facility 50 in the primary computer server 12 to the secondary coupling facility 64 in the secondary computer server 16 stops, then delete the temporary data in the primary coupling facility 50 and utilize the temporary data in the secondary coupling facility 64.

At step 86, the primary computer server 12 writes permanent data to the primary disk subsystem 14.

At step 88, the primary disk subsystem 14 replicates the permanent data to the secondary disk subsystem 18.

At step 90, the OS image 42 generates temporary data that is stored in the primary coupling facility 50.

At step 92, the OS image 42 replicates the temporary data from the primary coupling facility 50 the secondary coupling facility 64.

At step 94, the OS image 42 detects an operational error associated with either the primary computer server 12 or the primary disk subsystem 14. For example, an operational error occurs when the primary disk subsystem 14 does not respond to read requests or write requests from at leas tone of the OS images. Further, for example, an operational error occurs when at least one of the disks on the primary disk subsystem 14 has impaired or failed operation and the primary disk subsystem 14 sends an error message indicating the impaired or failed operation to at least one of the OS images. Further, for example, an operational error occurs when communication via one of the busses, such as the bus 30, fails such that replication of data between the primary disk subsystem 14 and the secondary disk subsystem 18 is prevented.

At step 96, the primary computer server 12 makes a determination as to whether replication of permanent data from the primary disk subsystem 14 to the secondary disk subsystem 18 is to be stopped. In one exemplary embodiment, a GDPS application executing on at least one of the OS images of the primary computer server 12 determines that replication of permanent data from the primary disk subsystem 14 to the secondary disk subsystem 18 is to be stopped when one of the OS images detect an operational error associated with either the primary computer server 12 or the primary disk subsystem 14. If the value of step 96 equals “yes”, the method advances to step 97. Otherwise, the method advance to step 116.

At step 97, the primary disk subsystem 14 stops replicating permanent data to the secondary disk subsystem 18 at a first time.

At step 98, the OS image 42 sends a disk replication suspend notification message to the OS image 62 in response to the primary disk subsystem 14 stopping replication of permanent data to the secondary disk subsystem 18.

At step 100, the OS image 62 sends a data replication freeze message to the primary disk subsystem 14, in response to receiving the disk replication suspend notification message from the OS image 42.

At step 102, the primary disk subsystem 14 sends messages to the OS images 42, 44, 44, 46, 48 indicating that a freeze on data replication has been initiated.

At steel 104, OS images 44, 46, 48 send redundant data replication freeze messages to the primary disk subsystem 14 in response to receiving the messages from the primary disk subsystem 14 indicating that a freeze on data replication has been initiated.

At step 106, the primary disk subsystem 14 sends messages to the OS images 44, 46, 48 indicating that a freeze on data replication has been initiated, in response to receiving the redundant data replication freeze messages from the OS images 44, 46, 48.

At step 108, the OS images 42, 44, 46, 48 place themselves into a disabled wait state where the OS images 42, 44, 46, 48 will not execute any instructions which stops any further updates to the temporary data in the primary coupling facility 50 and stops any further replication of temporary data from the primary coupling facility 50 to the secondary coupling facility 64, at the first time, in response to receiving messages from the primary disk subsystem 14 that the freeze on data replication has been initiated.

At step 110, the OS image 62 sends message to the primary computer server 12 instructing the primary computer server 12 to place OS images 42, 44, 46, 48 into a reset state where the OS images 42, 44, 46, 48 are no longer functional.

At step 112, the OS image 62: (i) displays a status message on the display device 20 indicating an operational effort associated with either the primary computer server 12 or the primary disk subsystem 14 has occurred, and (ii) displays another message requesting permission from a user for a site switch routine to be executed.

At step 113, the secondary computer server 16 makes a determination as to whether a user has granted permission for a site switch routing to be executed. If the value of step 113 equals “yes”, the method advances to step 114. Otherwise, the method is exited

At step 114, the OS image 62 executes the site switch routine which restarts execution of the OS images 42, 44, 46, 48 on the secondary computer server 16. At step 114, the method is exited.

Referring again to step 96, when the value of step 96 equals “no”, the method advances to step 116. At step 116, the primary computer server 12 makes a determination as to whether replication of temporary data from the primary computer server 12 to the secondary computer server 16 is to be stopped. If the value of step 116 equals “yes,” the method advances to step 118. Otherwise, the method is exited.

At step 118, the OS image 42 sends messages to the OS images 42, 44, 46, 48, 62 to temporarily stop writing temporary data to the primary coupling facility 50 which further stops replication of the temporary data from the primary coupling facility 50 to the secondary coupling facility 64.

At step 120, the OS image 42 sends messages to the OS images 44, 46, 48, 62 to induce the OS images 44, 46, 48, 62 to use data in the secondary coupling facility 64.

At step 122, the OS image 42 sends a message to the OS images 44, 46, 48, 62 to write temporary data to the secondary coupling facility 64 on the secondary computer server 16. After step 122, the method is exited.

The data backup system and the method for synchronizing a replication of permanent data and a replication of temporary data in the event of an operational error provide a substantial advantage over other systems and methods. In particular, the data backup system and the method provide a technical effect of stopping replication of permanent data from a primary disk subsystem to secondary disk subsystem and replication of temporary data from the primary computer server to the secondary computer server, at a substantially similar time, when an operational error is detected. As a result, a relatively long process of reconstructing the correct temporary data on a remote server when an operational error occurs is no longer need.

The above-described method can be at least partially embodied in the form of one or more computer readable media having computer-executable instructions for practicing the method. The computer-readable media can comprise one or more of the following: floppy diskettes, CD-ROMs, hard drives, flash memory, and other computer-readable media known to those skilled in the art; wherein, when the computer-executable instructions are loaded into and executed by one or more computers or computer servers, the one or more computers or computer servers become an apparatus for practicing the invention.

While the invention is described with reference to exemplary embodiments, it will be understood by those skilled in the art that various changes may be made and that equivalent elements may be substituted for elements thereof without departing from the scope of the invention. In addition, many modifications may be made to the teachings of the invention to adapt to a particular situation without departing from the scope thereof. Therefore, is intended that the invention not be limited the embodiments disclosed for carrying out this invention, but that the invention includes all embodiments falling with the scope of the appended claims. Moreover, the use of the terms first, second, etc. does not denote any order of importance, but rather the terms first, second, etc. are used to distinguish one element from another.

We claim:

1. A method for sychronizing a replication of permanent data between primary and secondary disk subsystems and a replication of temporary data between primary and secondary computer servers in the event of an operational error, comprising:
writing permanent data from the primary computer server to the primary disk subsystem;
replicating the permanent data from the primary disk subsystem to the secondary disk subsystem;
generating temporary data in the primary computer server;
replicating the temporary data from the primary computer server to the secondary computer server;
detecting the operational error;
stopping any further replication of permanent data from the primary disk subsystem to the secondary disk subsystem at a first predetermined time, in response to detecting the operational error; and
stopping any further replication of temporary data from the primary computer server to the secondary computer server at the first predetermined time, in response to detecting the operational error.

2. The method of claim 1, wherein detecting the operational error comprises detecting an operational error in either the primary disk subsystem or the primary computer server utilizing an operating a system image.

3. The method of claim 1, wherein stopping any further replication of permanent data from the primary disk subsystem to the secondary disk subsystem at the first predetermined time comprises:
sending a disk replication suspend notification message from a first operating system image on the primary computer server to a second operating system image on the secondary computer server; and
sending a data replication freeze message from the second operating system image on the secondary computer server to the primary disk subsystem.

4. The method of claim 1, wherein stopping any further replication of temporary data from the primary computer server to the secondary computer server comprises:
sending a first message from a first operating system image on the primary computer server to a second operating system image on the primary computer server; and
stopping a writing of temporary data from the second operating system image to a primary coupling facility of the primary computer server, in response to the first message, which stops replication of the temporary data from the primary coupling facility to a secondary coupling facility in the secondary computer server.

5. A data backup system, comprising:
a primary computer server;
a secondary computer server operably communicating with the primary computer server;
a primary disk subsystem operably communicating with the primary computer server;
a secondary disk subsystem operably communicating with the primary disk subsystem;
the primary computer server configured to write permanent data to the primary disk subsystem;
the primary disk subsystem configured to replicate the permanent data to the secondary disk subsystem;
the primary computer server configured to generate temporary data;
the primary computer server further configured to replicate the temporary data from the primary computer server to the secondary computer server;
the secondary computer server configured to detect an operational error and to send a message to the primary disk subsystem in response to detecting the operational error;
the primary disk subsystem further configured to stop any further replication of permanent data from the primary disk subsystem to the secondary disk subsystem at a first predetermined time, in response to the message; and
the primary computer server further configured to stop any further replication of temporary data from the primary computer server to the secondary computer server at the first predetermined time, in response to detection of the operational error.

6. The data backup system of claim 5, wherein the primary computer server is further configured to send a disk replication suspend notification message from a first operating system image to a second operating system image on the secondary computer server, the secondary computer server further configured to send a data replication freeze message from the second operating system image to the primary disk subsystem.

7. The data backup system of claim 5, wherein the primary computer server is further configured to send a first message from a first operating system image on the primary computer server to a second operating system image on the primary computer server, the second operating system image configured to stop writing temporary data to a primary coupling facility of the primary computer server, in response to the first message, which stops replication of the temporary data from the primary coupling facility to a secondary coupling facility in the secondary computer server.

8. One or more computer readable media having computer-executable instructions implementing a method for synchronizing a replication of permanent data between primary and secondary disk subsystems and a replication of temporary data between primary and secondary computer servers in the event of an operational error, the method comprising:
writing permanent data from the primary computer server to the primary disk subsystem;
replicating the permanent data from the primary disk subsystem to the secondary disk subsystem;
generating temporary data in the primary computer server;
replicating the temporary data from the primary computer server to the secondary computer server;
detecting the operational error;
stopping any further replication of permanent data from the primary disk subsystem to the secondary disk subsystem at a first predetermined time, in response to detecting the operational error; and
stopping any further replication of temporary data from the primary computer server to the secondary computer server at the first predetermined time, in response to detecting the operational error.

9. A method for synchronizing a replication of permanent data between primary and secondary disk subsystems and a replication of temporary data between primary and secondary computer servers in an event of an operational error, comprising:
replicating permanent data written from the primary computer server to the primary disk subsystem from the primary disk subsystem to the secondary disk subsystem.
replicating temporary data generated in the primary computer server from the primary computer server to the secondary computer server; and
in response to detection of the operational error, stopping any further replication of permanent data from the primary disk subsystem to the secondary disk subsystem and simultaneously stopping any further replication of temporary data from the primary computer server to the secondary computer server.

10. Apparatus for synchronizing a replication of permanent data between primary and secondary disk subsystems and a replication of temporary data between primary and secondary computer servers in an event of an operational error, comprising:
means for replicating permanent data written from the primary computer server to the primary disk subsystem from the primary disk subsystem to the secondary disk subsystem;
means for replicating temporary data generated in the primary computer server from the primary computer server to the secondary computer server; and
means responsive to detection of the operational error for stopping any further replication of permanent data from the primary disk subsystem to the secondary disk subsystem and simultaneously stopping any further replication of temporary data from the primary computer server to the secondary computer server.
